(19) United States
(12) Patent Application Publication
(10) Pub. No.: US 2012/0174804 A1
(43) Pub. Date: Jul. 12, 2012

(54) Power-Off-Protection Type of Safety Control Double Valve Applied to Pressing Machines

(76) Inventors: Fang Rong, Wuxi (CN); Zhengfeng Zhang, Wuxi (CN); Ming Lu, Wuxi Jiangsu (CN); Houlun Li, Wuxi (CN); Ming Zhuang, Wuxi (CN)

(21) Appl. No.: 13/497,051

(22) PCT Filed: Sep. 18, 2010
(86) PCT No.: PCT/CN10/01442

§ 371 Date: Mar. 19, 2012

(51) Int. Cl. F16P 3/00

(52) U.S. Cl. 100/347

(57) ABSTRACT

This invention covers to a kind of control valve, materially, it is a kind of Power-Off-Protection Type of Safety Control Double Valve applied to Pressing Machine. According to the technology proposal provided by this invention: The said power-off protection type of safety control double valve applied to pressing machines, including parallel type of double valve or cross-flow double valve; add safety valve to the output vent of parallel type of double valve or cross-flow double valve; configure at least one-aero-electric signal converter to the air flow passage from lower valve opening to compressed air output vent OUT of parallel type of double valve or cross-flow double valve; the output vent of parallel type of double valve or cross-flow double valve, is connective to the intake at one end of the safety valve; the said safety valve is a 2-position, 2-way normal open solenoid valve; the compressed air output vent of the said safety control double valve is located at one side of the safety valve, and the compressed air intake of safety control double valve is located at the other side relevant to the other side of compressed air output vent on the safety control valve.

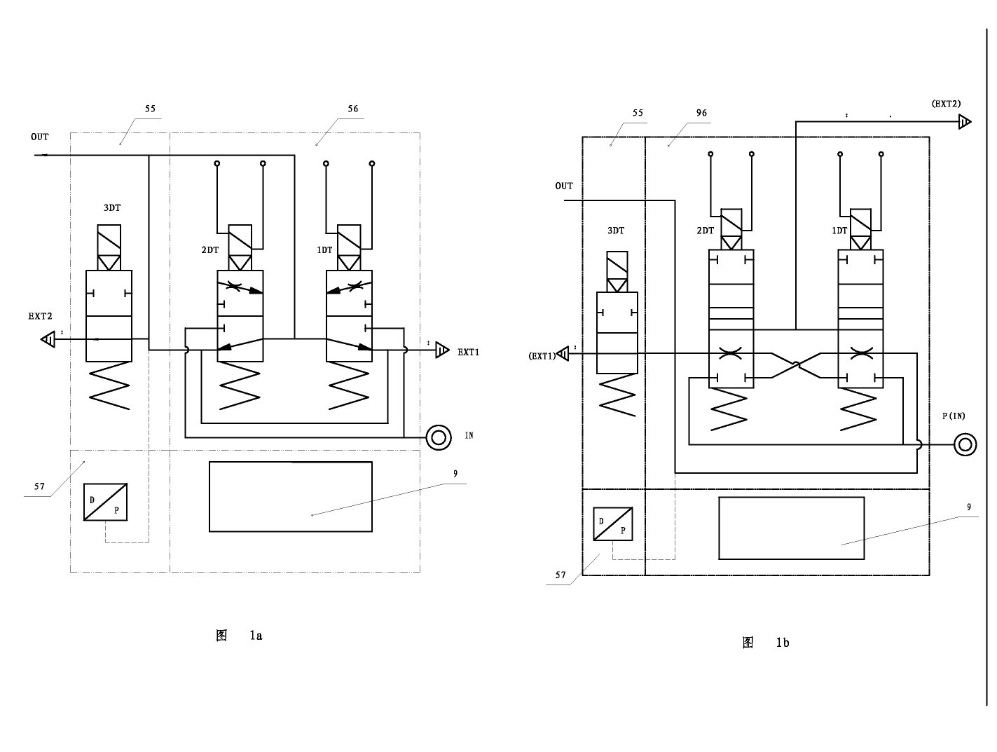

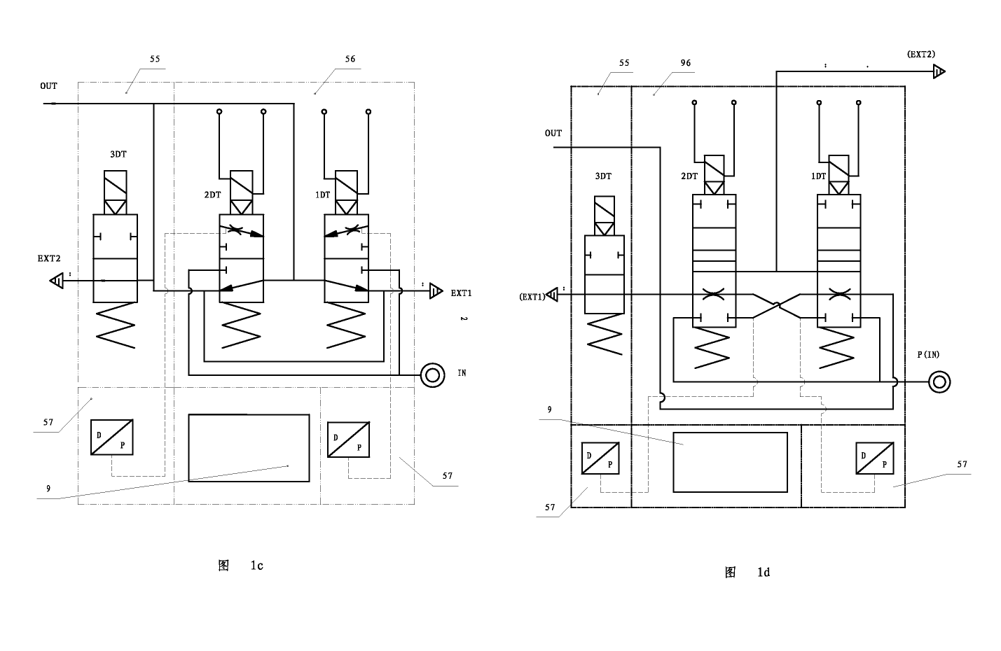

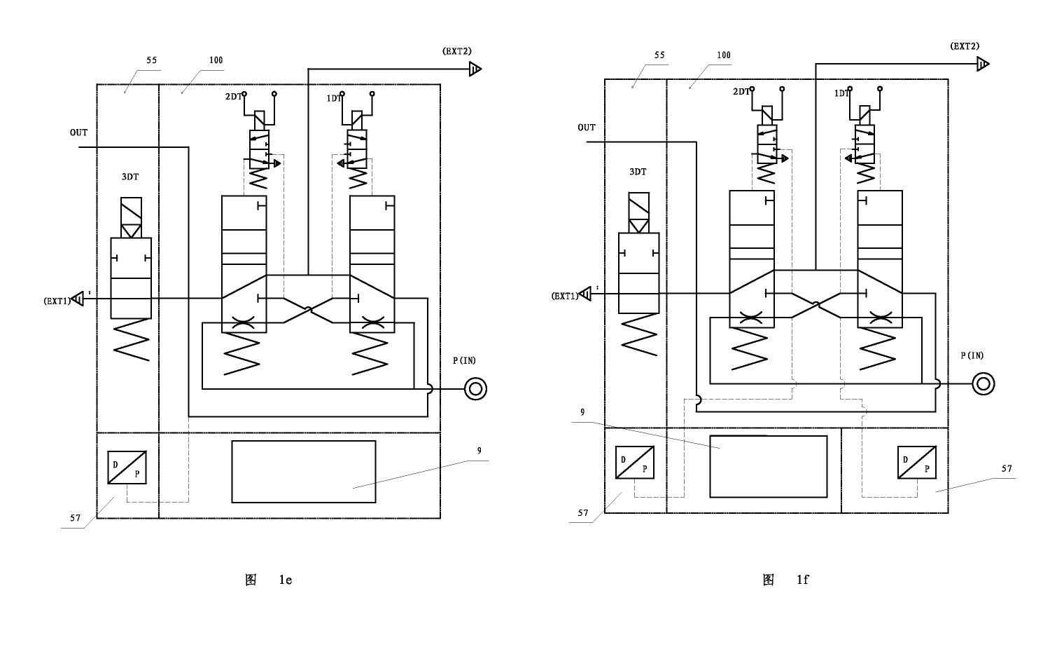

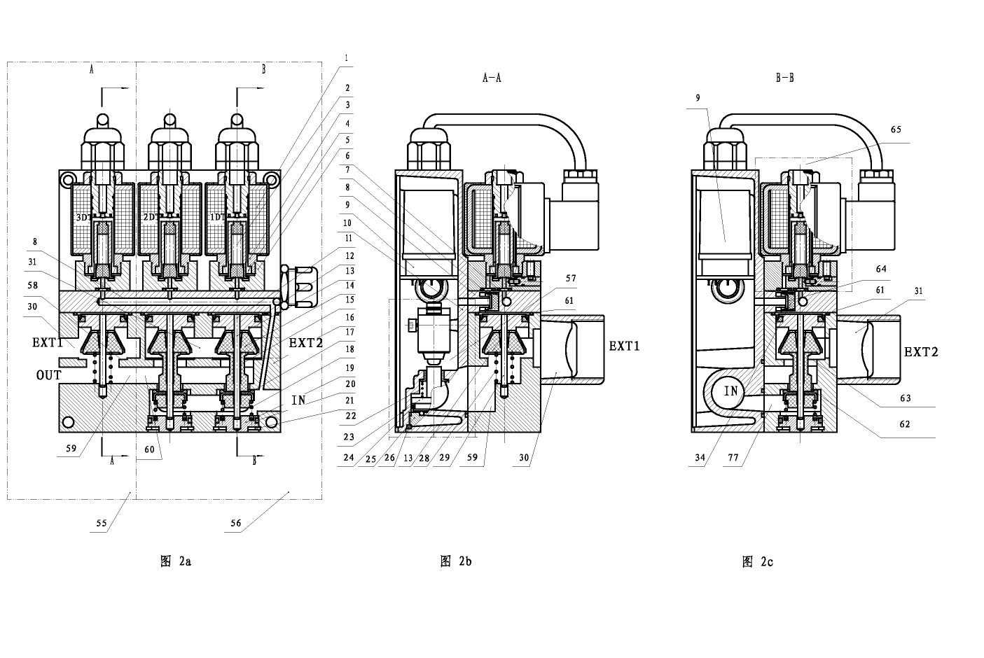

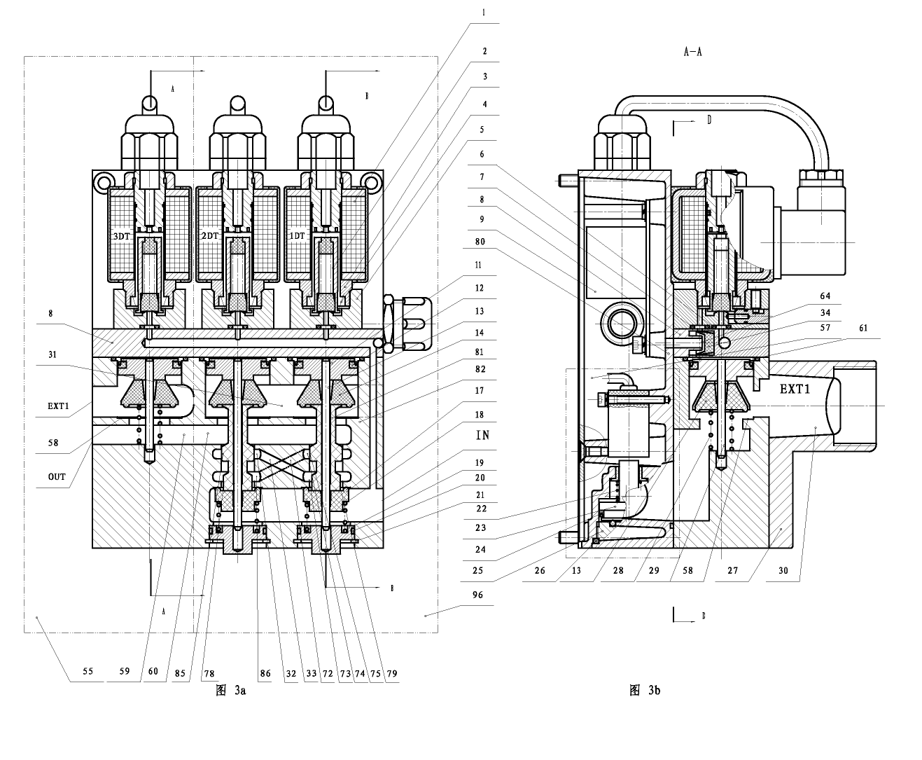

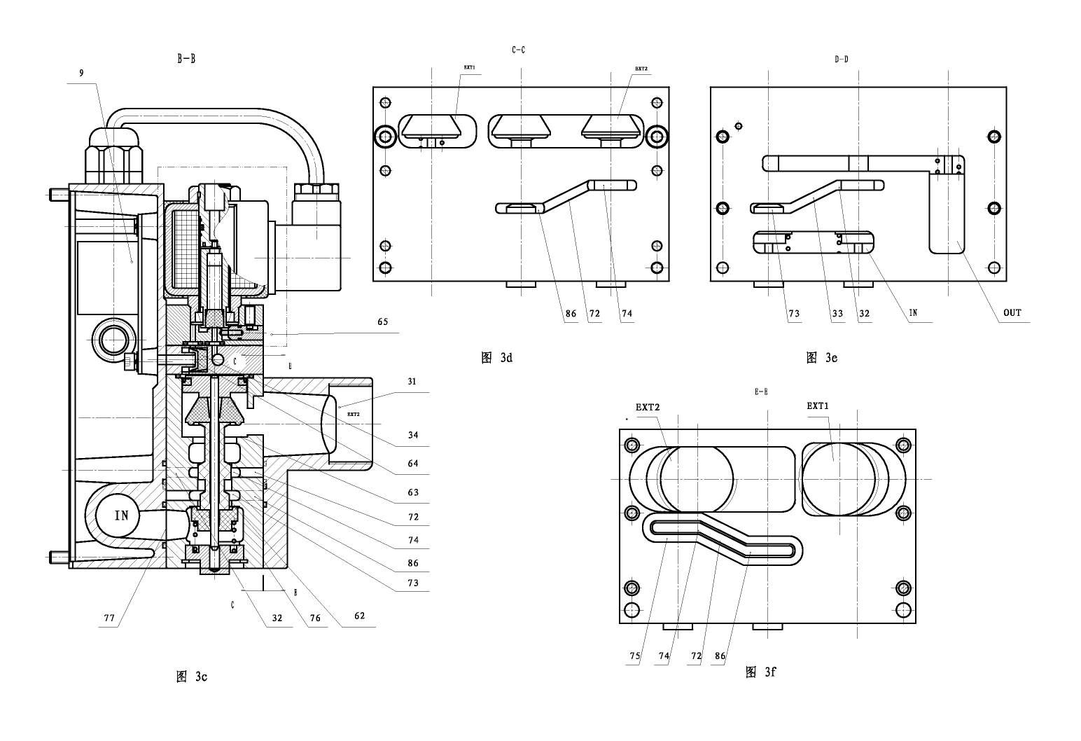

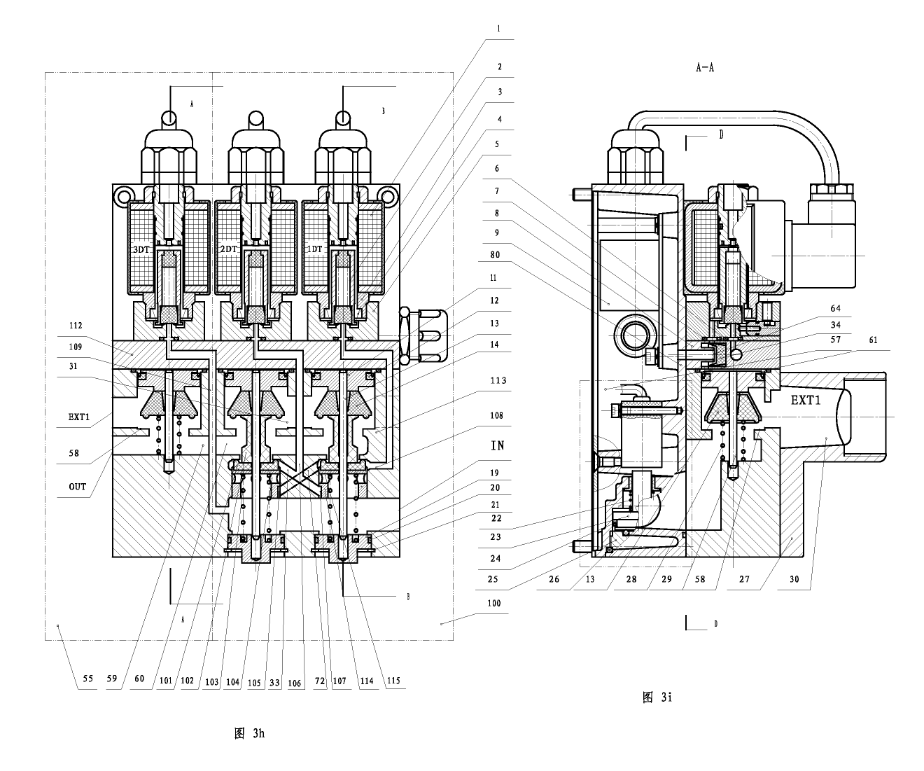

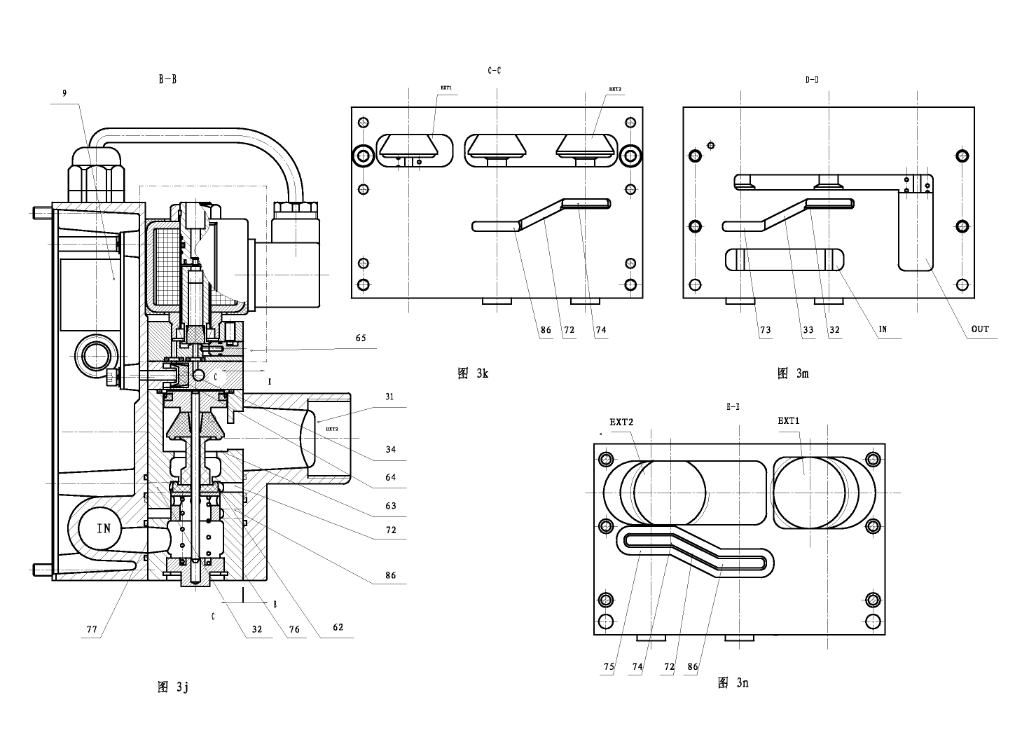

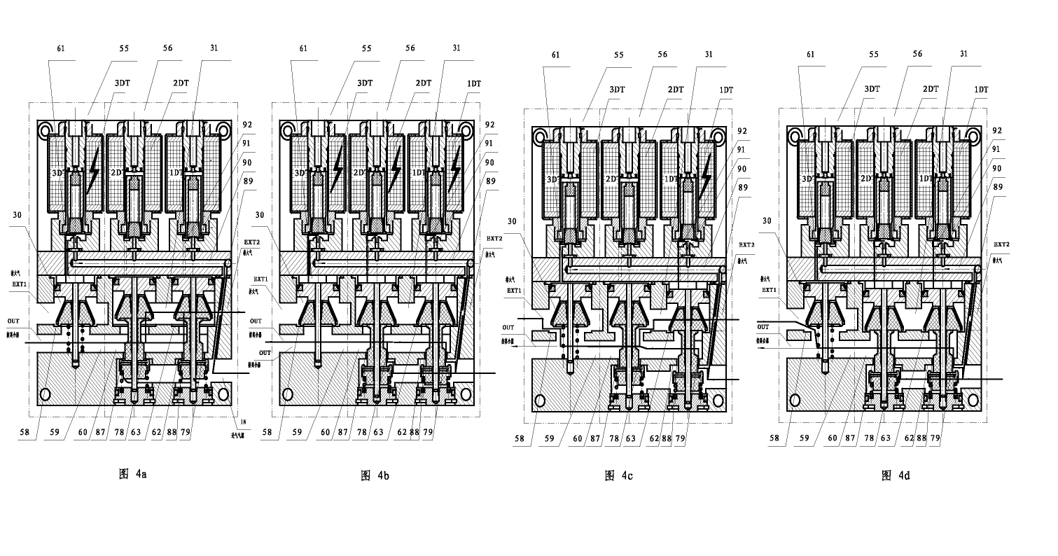

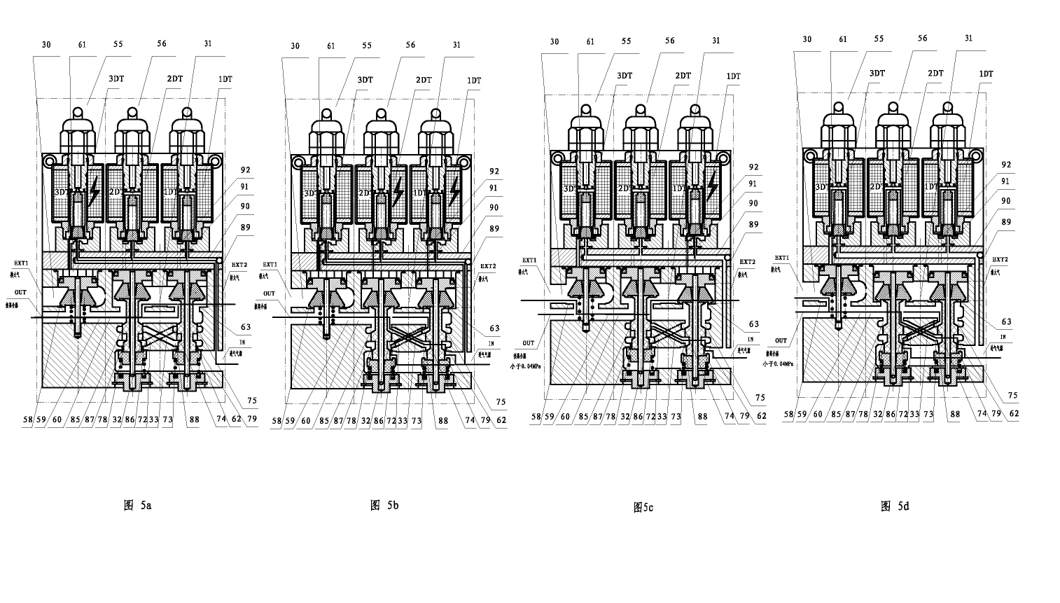

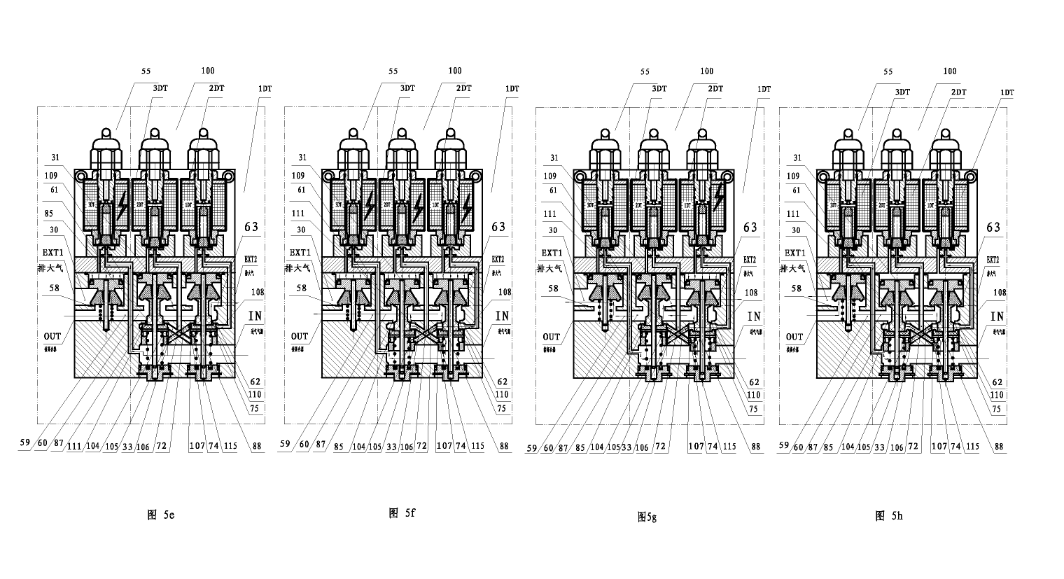

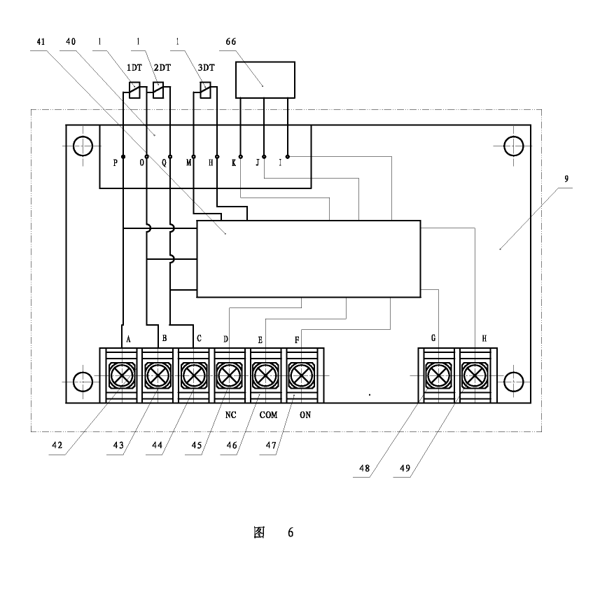

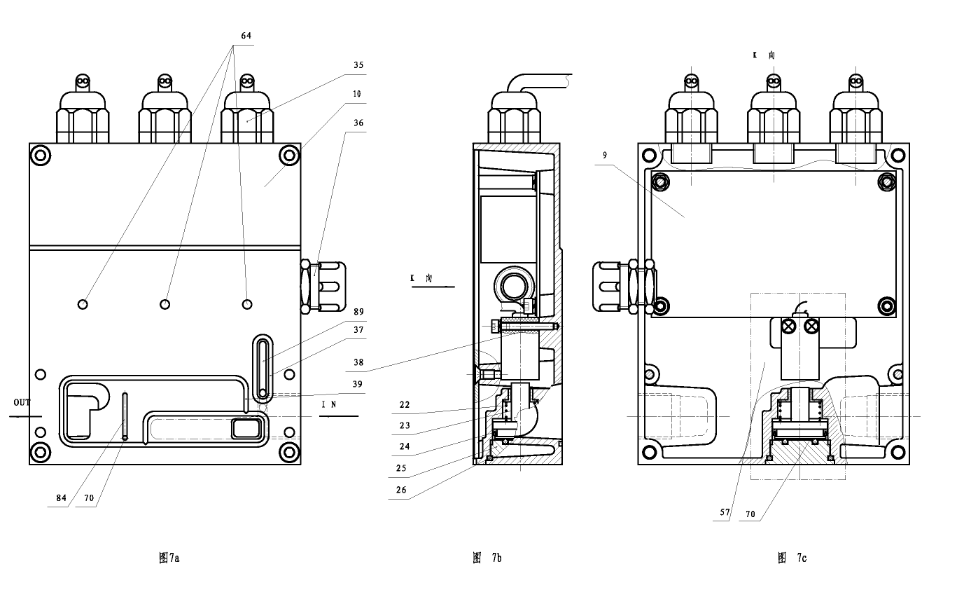

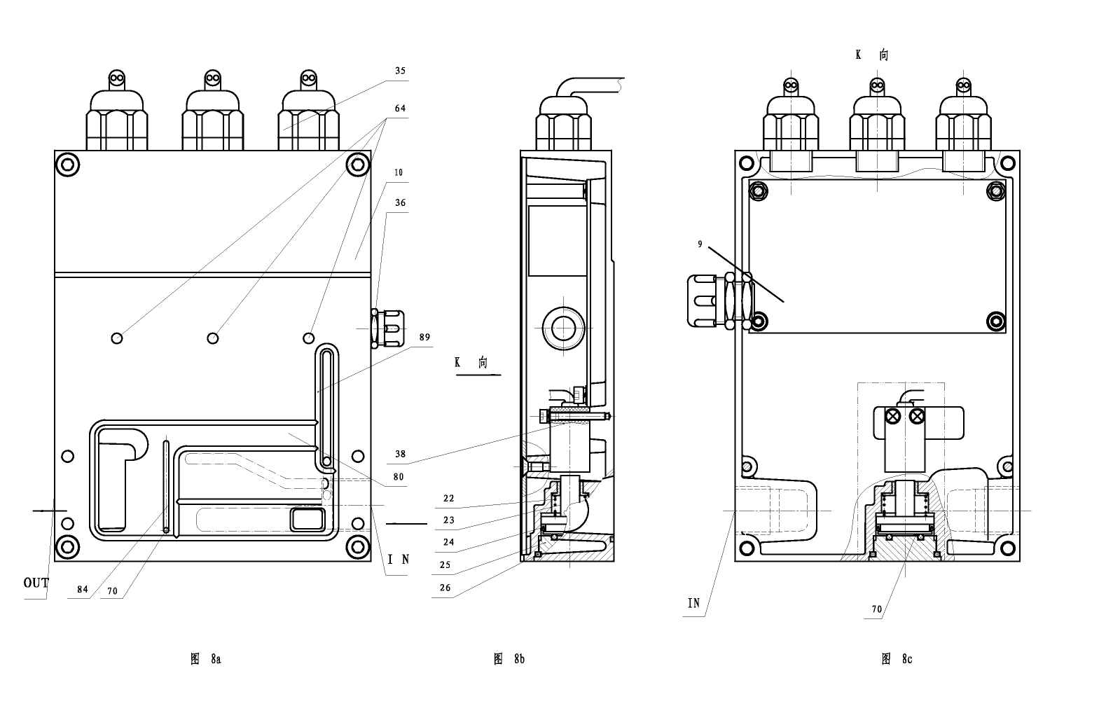

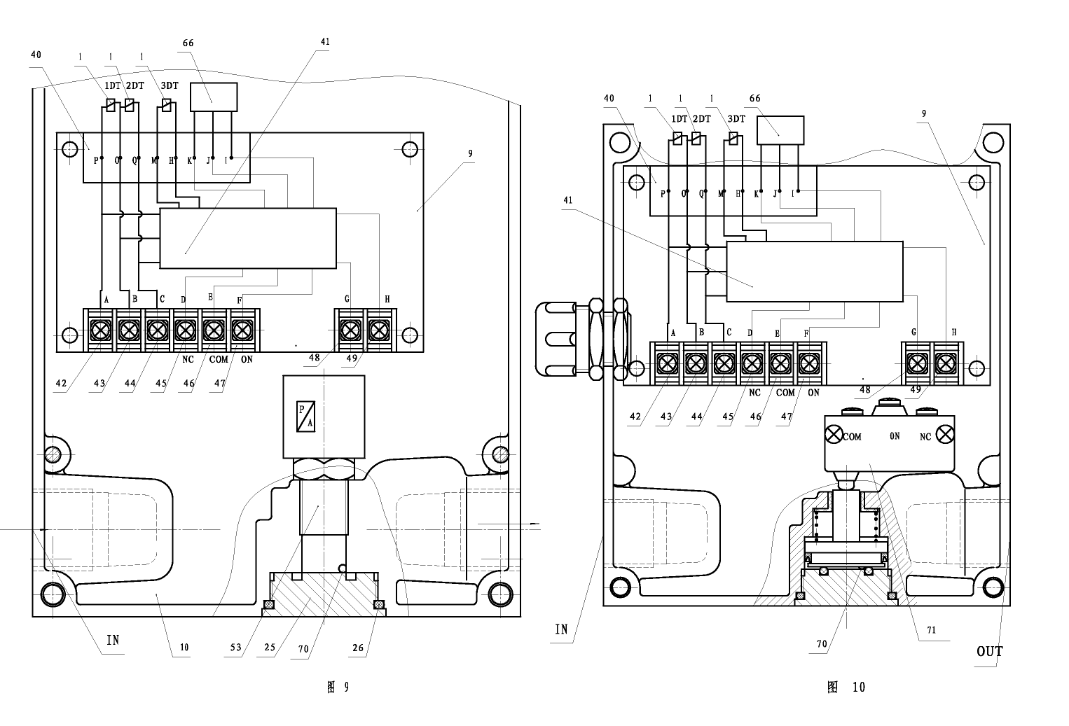

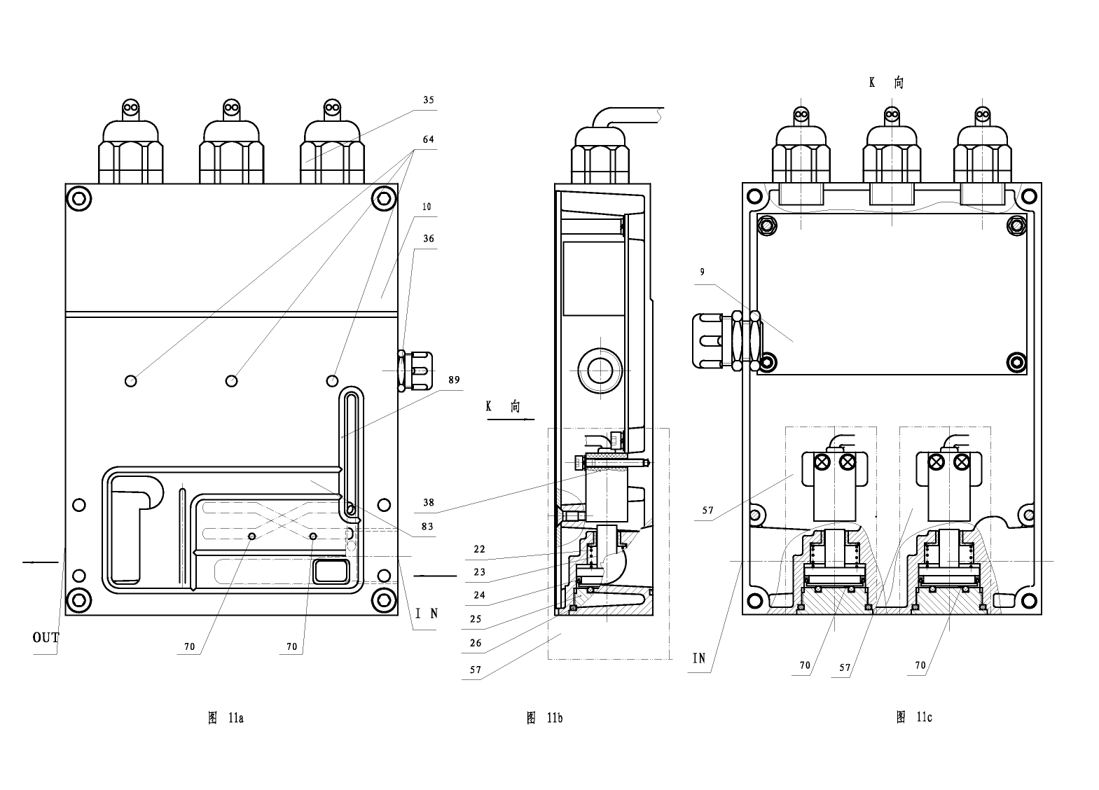

### TECHNOLOGICAL FIELD

The present invention refers to a kind of control valve, specifically, it is a kind of Power-Off-Protection Type of Safety Control Double Valve applied to Pressing Machine.

### BACKGROUND INFORMATION

Currently, either domestic or overseas, twin-valves used for control the action of friction-clutch of pneumatic clutch type of pressing machine; such kinds of double valves are all composed up of two groups of air inlet port, vent-port and exhaust port of single type of solenoid valve directly arranged in parallel or cross-imaging parallel ways. In this statement, the double valve composed up of direct paralleled inlet, vent and exhaust ports of main valve is called parallel-type of double valve and the cross-flow double valve in short; and same below. When the two groups of main valves of single type of solenoids are energized simultaneously, both groups of single type of solenoids reverse simultaneously; and thus, when the parallel type double valve or crossing-flow double valve or double cross crossing double valve works normally shall be same as a normal close 2 position Tee solenoid; if one group of valve core of parallel type of double valve or cross-flow double valve is invalid in operation—unable to open or close, parallel type of double valve or cross-flow double valve shall ensure to let the output pressure attenuate quickly to be lower than 0.04 MPa from the air intake port, and this is the main safety measure achieved by parallel type of double valve or cross-flow double valve. The design principle is within a work cycle, the trouble probability is small for failure to both groups of valve cores, and that makes a great improvement in working safety for parallel type of double valve or cross-flow double valve. Hence: there are design defects in either domestic or overseas parallel type of double valve or cross-flow double valve, including ZL200410085513.3 mentioned double valve which is composed up of two independent solenoid valve cores, i.e., whenever failure occurred at the same time to cores of both the two independent solenoids of parallel double valve or cross-flow double valve, such as the two independent solenoids of parallel double valve or cross-flow double valve are blocked simultaneously, the pressure of clutch controlled by parallel double valve or cross-flow double valve shall be helpless to attenuate to be below the starting pressure, and that shall results in press-machine stroking continuously.

“Safety Control Double Valve Applied to Pressing Machines”, the applicant referred in Patent Application No. 200910181314.5, when the two independent solenoids of safety control double valve encounter failure simultaneously, shall attenuate the pressure inner clutch to be below starting pressure. In order to achieve this target, the “Safety Control Double Valve Applied to Pressing Machines” equips an safety valve—which is a 2 position normal open solenoid—at the output end of the double valve in a serial way, and that makes a notable flow-decrease between output port of “Safety Control Double Valve Applied to Pressing Machines” and exhaust port. Experiment shows that the flow from output port to exhaust of “Safety Control Double Valve Applied to Pressing Machines” is ⅓ lower that of the common double valve in the same specification conditions. Furthermore, the safety valve of “Safety Control Double Valve Applied to Pressing Machines” switches for exhaustion under energized condition, while “Safety Control Double Valve Applied to Pressing Machines” shall control the pressure inner clutch to attenuate to below starting pressure. In case the pressing machine is not-energized, then, the exhaust port of the safety valve in the “Safety Control Double Valve Applied to Pressing Machines”closes, and the clutch controlled by “Safety Control Double Valve Applied to Pressing Machines” is unable to attenuate the pressure inner clutch through exhaust of the safety valve, and thus the safety valve loses its safety function, functional defect appears.

### CONTENT OF THE INVENTION

The purpose of the invention is to design a new power-off protection type of safety control double valve for pressing machines, and Safety Control Double Valve in short, which uses 2 groups of electric control signals of single type of solenoids in the double valve and the relevant air pressure signals—turned to electric sigials to form logic and/or relation—of the output from the double valve, so as to monitor and control the double valve; safety valve is added to aside the output end of the double valve, while one end of the safety valve is connected to the output port of the double valve, and the other end of safety valve is connected exhaust port, at the same time, the aero-electric signal converter is equipped at the air-pipeline between the lower valve opening of the double valve and pressed air output, and set inside the Safety Control Double Valve the signal drive circuit, or set that inside relevant controlled pressing machine, so as to promote the safety reliability of the said valve. Following to the technology proposal provided by this invention: the said Power-Off-Protection Type of Safety Control Double Valve Applied to Pressing Machines, includes air-intakes, outlets and exhausts of the 2 independent solenoids directly arranged in parallel way, or the intakes and outlets of 2 single solenoids cross-mirroring and to form cross-flow double valve together with exhausts in a parallel way; add safety valve to the output port of parallel type of double valve or cross-flow double valve; set monitor and control drive circuit in the said safety control double valve or inner circuit of relevant part of controlled pressing machine; the feature is: the output port of parallel type of double valve or cross-flow double valve is connected to the intake of the safety valve located at one end of the safety valve; the other end of the safety valve is connected to the exhaust valve, exhaust valve is connected to exhaust EXT1; the said safety valve is a 2 position normal open solenoid; set at lest one aero-electric signal converter to the compressed air pipeline between lower opening of said parallel type of double valve or cross-flow double valve and compressed air outlet; the connection of said electric signal converter and monitor and control drive circuit; the said independent solenoid and safety valves are all including pilot valve amounted on the pilot valve seat and the main valve beneath the pilot valve seat; the compressed air outlet OUT of the said safety control double valve located at one side of the safety valve, the compressed air Intake IN of the said safety control double valve located at the other side relative to OUT of compressed air outlet of safety control double valve.

The signal input ends of said monitor control drive circuit are connected respectively to the output terminals of aero-electric signal converter and two coils of parallel double valve or cross-flow double valve; the electric signals output from two coils of parallel double valve or cross-flow double valve are the 1^{st} and 2^{nd} signals, the output signals from aero-electric converter are the 3^{rd} and 4^{th} signals; the said 1^{st}, 2^{nd}, 3^{rd} or 4^{th} signal is sent to monitor control drive circuit for sampling, analyzing, comparing with control drive circuit for analyzing and comparing: if the 1^{st}, 2^{nd} and 3^{rd} or 4^{th} signals are all of high level or low level, that means the safety control double valve performs normally; in case there is difference electric levels in the 1^{st}, 2^{nd} 3^{rd} and 4^{th} electric signals, that means there is trouble in safety control double valve, sampling, analyzing, comparing control drive circuit shall drive instantly the power-off action for the safety valve, so as to release the pressure of compressed air in safety control double valve, and lock the output status of the said release, output trouble signal.

Configure external power supply port for the said monitor control drove circuit; only monitor control drive circuit is proficient to judge external monitor power and supplied to energize the 3^{rd} coil of safety valve simultaneously, shut up safety exhaust of the safety valve and can then the safety control double valve perform normally accomplish effective monitoring of the external monitor power supply by the safety control double valve and at the same time to accomplish self test of the safety performances before safety control double valve put into operation.

The exhaust-cavity formed from upper valve opening of parallel double valve, cross-flow double valve to the exhaust of double valve and exhaust-cavity formed from exhaust valve opening of safety valve to the exhaust valve vent are independent respectively; when the safety valve is power-off, open the safety exhaust vent of safety valve, the parallel valve or cross-flow double valve in the safety control double valve of control clutch are all lying in a safe status after the press encounters a sudden power-off, i.e., the compressed air vent of double valve in safety valve shall be connected through simultaneously with exhaust vent of safety valve and parallel double valve or cross-flow double valve, and thus to accomplish the redundant control as the safety feature of safety control double valve.

The said aero-electric signal converter is the aero-electric signal converter integrated with micro-switch; in the said micro-switch contained aero-electric signal converter, the signal piston is connected in a gliding way in cylinder, the piston-bar of the signal piston extrudes from one end of the said cylinder, the extruding part of the piston-bar can touch with micro-switch, which is mounted on the valve seat of the monitor-unit, and there is a signal back-cover at the other end of the said cylinder, there is signal reset-spring outside the piston-bar; the said valve seat of control unit locates at the side of valve body, and the said cylinder body locates on the said valve seat of control unit; the said micro-switch is connected to the monitor control drive circuit.

The said aero-electric signal converter is the aero-electric signal converter integrated with proximity-switch; in the said proximity-switch contained aero-electric signal converter, the signal piston is connected in a gliding way in cylinder, the piston-bar of the signal piston extrudes from one end of the said cylinder, the extruding part of the piston-bar is applicable to stretch near the proximity-switch induction surface, there is a signal back-cover at the other end of the said cylinder, and there is a signal reset spring outside the piston-bar; the said valve seat of control unit locates at the side of valve body, and the said cylinder body locates on the said valve seat of control unit; the said proximity-switch is connected to the monitor control drive circuit.

The said aero-electric signal converter is the electric signal converter integrated with transducer; in the said transducer contained aero-electric signal converter, the monitor control valve seat is set as the side of the valve body, and a cavity is set inner seat of the monitor unit, there is pressure-transducer in the said cavity, a signal back cover, which is used to locate and seal the pressure transducer, is placed at the cavity open end; the said pressure-transducer is connected to the monitor control drive circuit.

The feature of this invention covers:

1. Add side located safety valve, which is 2-position and 2-through normal open solenoid, at the output end of the double valve in safety control double valve, one end of the safety valve is connective to output vent of the double valve, the other end of the safety valve is connective to the output end of the double valve, and thus to let flow from compressed air vent to safety valve exhaust-vent of the safety control double valve free from influence by adding safety valve. This resolved the issue of notable flow reduction from the flow passage of compressed air output vent to exhaust vent of the “Safety Control Double Valve Applied in Pressing Machine” mentioned in 200910181314.5 , and conforms operation performance of safety control double valve to pneumatic friction clutch of pressing machines. Furthermore, the added side mounted safety valve actualizes that the double valve of the safety control double valve must be energized to close up the exhaust-vent of safety valve before operation, the safety valve shall be free of action when the double valve of the safety control double valve operates normally, and safety valve must act to open the exhaust vent of the safety valve when the double valve of the safety control double valve encounters trouble, so as to attenuate the pressure inner clutch, which is controlled by the safety control double valve, to be below starting pressure.

2. It is also applicable to set monitor control drive circuit inner safety control double valve or relevant controlled pressing machine accordingly. Besides to set up, in the monitor control drive circuit, double valve and safety valve coils output terminals, double valve control terminals, aero-electric converter input terminals, fault-signal output terminals to out put signals when trouble encountered, and “sampling, analyzing, comparing control drive circuit”, it is also needed to set up special terminals for monitor power supply. The operation power supply for safety valve shall only be supplied by monitor power supply; it is a must to connect with monitor power supply before normal operation of the double valve, and at the same time, to energize the third coil of the safety valve, and make the safety valve act to shut up the exhaust vent of the safety valve and to accomplish self test for safety functions of the safety control double valve. Two coils of the safety control double valve collects 2 electric signals and 1 aero-signal converted electric signal through he converter (also applicable to collect the 2 electric signals issued by pressure switches of 110 and 111 in double valve (cf. DWG 9) formed by single type of valves mentioned in ZL200410085513.3, and another electric signal converted from aero-signal), and send simultaneously to monitor control drive circuit for analyzing and comparing in safety control double valve; it means normal performance of the safety control double valve if the aforementioned 3 signals are of the same high or low electrical level; it would mean that there is trouble in the safety control double valve if any one of the three electric levels is different from the others, then the monitor control drive circuit shall drive instantly the circuit to activate the safety valve to let power off to the 3^{rd} coil of the safety valve to open the safety exhaust vent of the safety valve, release the pressure of compressed air output vent of the safety control double valve, and lock the status of the said release status, putout signal of trouble. Achieve the safety control double valve by using means of logic monitoring of X/OR, so as to achieve the aim of safety control no matter whether the safety control double valve is under any trouble status, including both of the 2 single solenoids of the double valve encountered troubles.

3. The safety valve exhaust vent and the exhaust vent of double valve are mutually independent respectively. When the safety control double valve operates normally, there would be free of exhaustion from the exhaust-vent, the compressed air at the safety control double valve exhaust-vent shall exit to the atmosphere through the silencer mounted on the double valve exhaust-vent therefore, the working frequency of silencer mounted on the safety valve exhaust vent is far more lower than that of the silencer mounted on the double valve exhaust vent; the silencer mounted on the safety valve is not easily blocked as compared with the silencer mounted on the double valve exhaust vent; when the silencer mounted on the exhaust vent of double valve is blocked, the monitor circuit of safety control double valve can surely detect the result of that, and drive the safety valve for action, to power-off the 3^{rd} coil, open exhaust-vent of safety valve and to attenuate the pressure inner clutch, which is controlled by safety control double valve, to be below the starting pressure, and lock the aforementioned release status, output trouble signal, and achieve the aim of safety valve control.

Advantage of present invention covers:

1. Since such kinds of safety control double valve uses the technical principles of: “XOR” logic monitoring, i.e., whenever there is any trouble occurred to the double valve, such kind of double control valve actualizes closed-loop control to itself, once trouble occurred to the double valve, including the 2 valve cores blocked at the same time, the monitor control drive circuit shall activate instantly, and let power-off the 3^{rd} coil of the safety valve to open the safety valve exhaust vent and release the pressure inner clutch connective to the compressed air exit of the safety control double valve, and to attenuate the said pressure be smaller than 0.04 MPa. The double valve formed by single valves mentioned in ZL200410085513.3 can not realize such a functional performance. With reliable and theoretical calculation, under same conditions, the safety reliability in performance of safety control double valve manufactured with XOR logic monitoring technical principle is 400 times that of the original double valve.

2. According to this proposal 1, add a side mounted 2-position 2-way safety solenoid valve at the output end of double valve in the safety control double valve, one end of the safety valve is connective to the exit of double valve, and the other end of safety valve is connective to the exhaust-vent of the double valve, so as to let the compressed air flow be free of influence from exit of safety control double valve to the exhaust-vent of the safety valve. This resolves the issue of How-rate notably deducted in the How-passage from “Safety Control Double Valve Applied in Pressing Machines” output vent to exhaust vent mentioned in patent application 200910181314.5, and meets the operation and control requirements for safety control double valve to pneumatic friction clutch of pressing machines. Furthermore, Compared with Patent Application 200910181314.5 mentioned a “Safety Control Double Valve Applied in Pressing Machines” output port with a serial 2-position and Tee normal open solenoid used as a safety valve, it features more laconic in structure, and hence yields to a great promotion in reliability of the safety control double valve.

Since the configuration of safety valve in this proposal is to open exhaust-vent of the safety valve when power-off, it ensures that when the pressing machine encounters a sudden power failure, the safety valve and double valve of safety control double valve set per this proposal shall all be at safety status, i.e., the output opening is connective with exhaust-vent of double valve and exhaust-vent of safety valve as well, and thus to achieve the characteristic redundant control of the safety control double valve, while it is not available to meet this function requirement by “Safety Control Double Valve Applied in Pressing Machines” mentioned in Patent Application 200910181314.5.

Since the configuration of safety valve in this proposal is to open exhaust-vent of the safety valve when power-off, therefore, it is a must to energize the safety valve and close-up exhaust vent of the safety valve before normal operation of the double valve in safety control double valve per the design of this proposal; the safety valve is free from action when the double valve in safety control double valve operates normally, and the safety valve must act to open exhaust-vent of the safety valve, and attenuate the pressure inner safety control double valve controlled clutch to be lower than than the pressure for starting when trouble occurred to the double valve in the safety control double valve. In order to actualize this function, the control and monitor drive circuit of relevant safety control double valve is equipped with a special monitoring power socket, the monitor power supply must be connected before normal operation of the double valve, and at the same time to energize the 3^{rd} coil of the safety valve, shut-up the exhaust-vent of the safety valve and accomplish the safety performance self-test for the safety control double valve before operation. And this also raises the action frequency of the safety valve, which avoids the defect of probably invalidness of safety function yielded from long period of idleness of the “Safety Control Double Valve Applied in Pressing Machines” mentioned in Patent Application 200910181314.5.

3. The exhaust vent of safety valve and double valve of safety control double valve designed per this invention is independent from each other, when block of silencer mounted on the exhaust-vent of double valve is detected by monitor control drive circuit of the safety control double valve, the safety valve is instantly activated to open the exhaust vent of the safety valve and let the compressed air through output OUT to evacuate rapidly from the exhaust-vent of safety valve at the same time, and lock the said release status, output trouble signals as well. Hence to avoid effectively the dangerous trouble yielded from blocking in silencer of double valve.

4. Safety control double valve designed per this invention, is to add output end side-mounted safety valve and output-vent mounted aero-electric converter device to the original double valve, and set inside a tiny electric analysis and control device, i.e., “monitor-control-drive circuit”, and integrated them into one body, which makes a solid foundation for product minimization, high-reliability and the future product marketing and promotion.

Therefore, this invention resolves mainly, under the premise of ensuring the characteristics of flow rate in the flow passage from double valve output opening to exhaust-vent and other features, the issue of its controlled clutch pressure unable to attenuate to be lower than starting pressure when 2 groups of single solenoids in double valve encountered trouble, and at the same time to yield to continuous punching of pressing machine, besides, it resolves the issue that the safety valve loses its safety features when encounters with sudden power failure to the pressing machine.

### NOTES TO THE ATTACHED DWGS

DWG 1a: Principle of Parallel Safety Control Double Valve—Aero-Electric Converter at Double Valve Output Opening

DWG 1b: Principle of Cross-Flow Safety Control Double Valve—Aero-Electric Converter at Double Valve Output Opening

DWG 1c: Principle of Parallel Safety Control Double Valve—No Aero-Electric Converter at Double Valve Output Opening

DWG 1d: Principle of Cross-Flow Safety Control Double Valve—No Aero-Electric Converter at Double Valve Output Opening

DWG 1e: Principle of Double Cross Cross-Flow Control Double Valve—Aero-Electric Converter at Double Valve Output Opening.

DWG 1f: Principle of Double Cross Cross-Flow Control Double Valve—No Aero-Electric Converter at Double Valve Output Opening.

DWG 2a Structure of Parallel Type of Double Valve

DWG 2b A-A View of DWG 2a

DWG 2c B-B View of DWG 2a

DWG 3a Structure of Cross-Flow Safety Control Double Valve

DWG 3b A-A View of DWG 3a

DWG 3c B-B View of DWG 3a

DWG 3d C-C View of DWG 3c

DWG 3e D-D View of DWG 3b

DWG 3f E-E View of DWG 3c

DWG 3h Structure of Double-Cross-Flow Safety Control Double Valve

DWG 3i A-A View of DWG 3h

DWG 3j B-B View of DWG 3h

DWG 3k C-C View of DWG 3j

DWG 3m D-AD View of DWG 3i

DWG 3n E-E View of DWG 3j

DWG 4a Operation Status: 2 Not Energized Coils of Double Valve in Said Parallel Double Valve

DWG 4b Operation Status: 2 Energized Coils of Double Valve in Said Parallel Double Valve

DWG 4c Operation Status: Sketch of 1 Single Valve of Double Valve in Said Parallel Double Valve Troubled.

DWG 4d Operation Status: Sketch of Double Valve in Said Parallel Double Valve at Dangerous Trouble State

DWG 5a Operation Status: 2 Not Energized Coils of Double Valve in Said Cross-Flow Double Valve

DWG 5b Operation Status: 2 Energized Coils of Double Valve in Said Cross-Flow Double Valve

DWG 5c Operation Status: Sketch of 1 Single Valve of Double Valve in Said Cross-Flow Double Valve Troubled

DWG 5d Operation Status: Sketch of Double Valve in Said Cross-Flow Double Valve at Dangerous Trouble State

DWG 5e Operation Status: 2 Not Energized Coils of Double Valve in Said Double-Cross-Flow Double Valve

DWG 5f Operation Status: 2 Energized Coils of Double Valve in Said Double-Cross-Flow Double Valve

DWG 5a Operation Status: Sketch of 1 Troubled Single Valve of Double Valve in Said Double-Cross-Flow Double Valve

DWG 5h Operation Status: Sketch of Double Valve in Said Double-Cross-Flow Double Valve at Dangerous Trouble State

DWG 6a Structure of Monitor Control Drive Circuit of Safety Control Double Valve

DWG 7a Structure of Aero-Electric Signal Converter of proximity Switch Type in Monitor Unit of Parallel Safety Control Double Valve

DWG 7b Left View of DWG 7a

DWG 7c K View of DWG 7b

DWG 8a Structure of Aero-Electric Signal Converter of proximity Switch Type in Monitor Unit of Cross-Flow Safety Control Double Valve

DWG 8b Left View of DWG 8a

DWG 8c K View of DWG 8b

DWG 9 Sketch of Monitor & Control Unit of Aero-Electric Converter Composed of Transducer

DWG 10 Sketch of Sketch of Monitor & Control Unit of Aero-Electric Converter Composed of Micro-Switch

DWG 11a Structure of Monitor-Control Unit of Cross-Flow Safety Control Double Valve Achieving Monitoring Not Mounted at Exit OUT of Double Valve

DWG 11b Left View of DWG 11a

DWG 11c K View of DWG 11a

### SPECIFIC WAYS OF IMPLEMENTATION

Safety control double valve includes double valve and safety valve, the said double valve includes parallel double valve, cross-flow double valve, double-cross-flow double valve; parallel type of double valve and safety valve formed parallel safety control double valve, cross-flow double valve and safety valve formed cross-flow safety control double valve, double-cross-flow double valve and safety valve formed double-cross-flow double safety control valve.

Design principle: By utilizing energizing simultaneously 1^{st} coil 1DT and 2^{nd} coil 2DT of 2 coil 1 of 2 pieces of pilot solenoid in parallel type of double valve 56 or cross-flow types of double valve 96 and double-cross-flow double valve 100 referred in DWGs of 1a, b, c, d, e, and f, the, air flow passage from the lower opening 62 of safety control double valve to compressed air output vent OUT is wit-h high air pressure, then, the aero-electric signal converter 57 configured in the air flow passage from lower valve opening 62 to compressed air output exit OUT issues high air pressure signal. In case power down occurred at the same time to 1^{st} coil 1DT and 2^{nd} coil 2DT of double valve, the flow passage from lower valve opening 62 to compressed air output exit OUT pressure gauge reading shall be 0, then, the aero-electric signal converter 57 configured in the air flow passage from lower valve opening 62 to compressed air output exit OUT issues 0 air pressure signal, i.e., the safety control double valve is under normal operation status. It indicates that the safety control double valve is under abnormal operation state in case this principle is violated. Thus, 2 controlled signals of double valve and the air pressure signal of aero-electric signal converter configured in the air flow passage from lower valve opening 62 to compressed air output exit OUT forms logic relation of XOR. Follow this logic relation to design monitor control drive circuit 9 for the safety control double valve , by collecting energizing signals from 2 solenoids in the double valve, and air pressure signal from aero-electric signal converter configured in he air flow passage from lower valve opening 62 to compressed air output exit OUT to carry out comparison and analysis, if trouble takes place in the safety control double valve, the safety control double valve is to issue trouble signal instantly and to send a drive signal to safety valve 55, and self-holding as well. As is stated aforesaid, 1^{st} coil 1DT and 2nd coil 2DT are the 2 coils “1” of the double valve, while the 3^{rd} coil 3DT is coil of safety valve 55; “+” means the said 3^{rd} coil 3DT is energized, and “−” means power-down; K is the signal issued by aero-electric signal converter 57 at the output exit 60 of safety control double valve: “+” means high air pressure, “−” means 0 or low air pressure, and at this moment, the relevant logic relationship between the 3^{rd} coil of safety valve and 1 at coil 1DT , 2^{nd} coil 2DT and air pressure signal K shall, be X-OR-N, and the relevant states are shown in table 1.

TABLE 1

| 1DT | 2DT | K | 3DT | Description of State |
|---|---|---|---|---|
| + | + | + | + | Normal Operation State |
| − | − | − | + | |
| + | − | − | − | Trouble state |
| − | + | − | − | |
| + | + | − | − | |
| + | − | + | | Dangerous trouble state. When blocking |
| − | + | + | − | occurred to silencer of the double valve, |
| − | − | + | − | or clutch spring failure from fatigue and |
| | | | | encountered failure to one of the valve |
| | | | | core of the double valve at the same time, |
| | | | | 2 solenoids in double valve troubles together |
| | | | − | |

The structure of parallel types of double valve designed per this proposal is shown, in DWGs of 2a, b, and c.

DWGs 2a, 2b, 2c: 1. Coil, 2. Moving core, 3. Static core component 4. Pilot reset spring 5. Pilot valve body, 6. Pilot intake O-ring, 7. Pilot outlet O-ring, 8. Pilot valve seat, 9. Monitor-control-drive circuit, 10. Parallel type of double valve monitor valve seat, 11. Piston, 12. V-ring, 13. Valve bar, 14. V-blocking, 15. Parallel type of double valve spacer, 16. Valve body of parallel double valve, 17. Lower blocking, 18. Double valve reset spring, 19. Lower end cap, 20. Lower end cap O-ring, 21. Lower cap hole baffle ring, 22. Signal reset spring, 23. Signal piston, 24 signal V-ring, 25. Signal back cover, 26. O-ring, 28. Safety valve reset spring, 29. Safety valve rod, 34. Quick-exhaust blocking. 55 in DWGs 2a, b, c are safety valve accordingly, 56. Parallel type of double valve, 57. Aero-electric signal converter 58 is Safety valve exhaust vent, 59. Input vent of safety valve, 60. Output vent of double valve, 61. Control cabin for safety valve and double valve, 62 lower valve opening of double valve, 63. Upper opening of double valve, 65. Pilot valve, 70. Air pressure sampling port for aero-electric signal converter. EXT1: Safety valve vent, connective to air-exhaust cavity 30 of the safety valve. EXT2: Double valve vent, connective to air-exhaust cavity 31 of the double valve.

Of cross-flow double valve designed per this design proposal, please confer DWGs of 3a, b, c, d, e, f for relevant structure accordingly.

In DWGs of 3a [symbol] b [symbol] c [symbol] d [symbol] e [symbol] f, except 96 of a cross-flow double valve, 27. Exhaust valve seat of cross-flow double valve, 93. Cross-shaped-ring 80. Monitor unit valve seat for cross-flow double valve, 81. Cross-flow double valve spacer, and 82. Cross-flow valve body are different, the structures of other parts and components are the same with that with safety control double valve parallel type of double valve coverings, and there are also configured with 1^{st} imaging terminals of 32, 74 on valve body of cross-flow double valve 82, 2^{nd} imaging terminals of 86,73 and use 2 un-connective flow passages of 33,72 to connect together the 1^{st} and 2^{nd} imaging terminals cross and imaging respectively and accordingly: flow passage 33 is connective to the 1^{st} imaging terminal 32 and 2^{nd} imaging terminal 73, flow passage 72 is connective to 1^{st} imaging terminal 74 and 2^{nd} imaging terminal 86, as seen in DWGs 3d, e, there are 1^{st} throttle columns of 85, 75 and 2^{nd} throttle columns of 78, 79 configured on 2 spacers for cross-flow double valve 96, hereinto, the 1^{st} throttle columns of 75, 85 are matching along with 1^{st} imaging terminals of 74, 32, and 2^{nd} throttle columns matching along with throttle holes of 87, 88 on body of cross-flow double valve 82 respectively.

Of double-cross-flow double valve designed per this design proposal, please confer DWGs of 3h, i, j, k, m, n for relevant structure accordingly.

In DWGs of 3h, i, j, k, m, n, except double-cross-flow double valve 100, double-cross-flow double pilot valve seat 112, double-cross-flow double valve spacer 102, body of double-cross-flow double valve 113, lower blocking 103, lower valve core 114 and reset spring 103 are different, the structures of other parts and components are the same with that used in cross-imaging paralleled cross-flow double valve 96, and there are also configured with 1^{st} imaging terminals of 32, 74 on valve body of double-cross-flow double valve 113, 2^{nd} imaging terminals of 86,73 and use 2 un-connective flow passages of 33, 72 to connect together the 1^{st} and 2^{nd} imaging terminals cross and imaging respectively and accordingly: flow passage 33 is connective to 1^{st} imaging terminal 32 and 2^{nd} imaging terminal 73, flow passage 72 is connective to 1^{st} imaging terminal 74 and 2^{nd} imaging terminal 86. There are 1^{st} throttle columns of 85, 75 and 2^{nd} throttle columns 78, 79 configured on 2 spacers 102 for double-cross-flow double valve 100, matching along with throttle holes 87, 88 configured on valve body 113 of double-cross-flow double valve, while throttle columns 85, 75 configured on the spacer of the double-cross-flow double valve and throttle holes 87, 88 configured on valve body 113 of double-cross-flow double valve formed 2 circular throttle flow passages 111, 110 correspondingly to the double-cross-flow double valve. Furthermore, at lower blocking 101, valve core 114 is configures to the lower end co axially, reset spring 103 is configured to lower end of lower valve core coaxially, as well, and configure circular throttle columns 105, 107 to the lower part of valve core 114 and at the same time, configure also master circular intake flow passages 104, 115 and connective to intake vent IN.

In DWG 6, P, O, Q are respective output terminals of double valve coil in monitor-control-drive circuit 9, and M, H stand for output terminals of the coil in safety valve; aero-electric converter input terminals K, J, I, form 8-core cable receptacle 40, sampling-analyzing-comparing control drive circuit 41, double valve control interface terminals 42, 43, and 44, trouble monitor output terminals 45, 46 and 47, monitor power supply terminals 48, 49.

From DWGs of 2a, b, c and 3a, b, c, it is clear that, no matter with parallel safety control double valve or cross-flow safety control double valve, there are the same pilot coil 1, moving core 2, static core component 3, pilot reset spring 4, pilot valve body 5, pilot ventilation O-ring 6, 7 formed 3 pieces of same 2-position Tee pilot solenoids, and they are mounted on the pilot seats 8 respectively, quick blocking is placed in the pilot valve seat 8, and the pilot valve seat 8 is applicable to be mounted on valve body 16 of parallel double valve, or valve body 82 of cross-flow double valve 82. While the main valve component is composed of 3 same sets of piston 11, V-coil 12, V-blocking 14, and 2 groups of same valve rod 13, parallel double valve spacer 15 or cross-flow double valve spacer 81, lower blocking 17, double valve reset spring 18, lower end cap 19, lower end cap O-ring 20, lower end hole lid baffle ring 21, a parallel double valve body 16 or cross-flow double valve body 82, safety valve reset spring 28, safety valve rod 29. Hereinto, the valve core component of the master valve is composed up of piston 11 of the master valve of parallel double valve 56, V-ring covering piston 11 and the valve rod in the central hole of piston. The safety valve core of parallel or cross-flow double valve is made up of putting V-blocking 14 into the valve core center, and then putting it into parallel double valve spacer 15 or cross-flow double valve spacer 81, and at the same time, pressing safety valve rod 29 into piston 11 central hole, putting on the V-ring 12, into V-blocking 14, safety valve reset spring 28. Put the parallel double valve core component or cross-flow double valve core into corresponding parallel double valve body 16 or cross-flow double valve body 82 into respective control cabin 61, put respectively the 2 groups of lower blocking 17 and reset spring 22 to parallel or cross-flow lower part of double valve body, and then, cover with O-ringed 20 lower end cap 19, and clamp it with baffle ring; The feature in structure for parallel or cross-flow double valve is that the internal cavity of parallel double valve body 16 or cross-flow double valve body 82, valve core of parallel or cross-flow double valve body, safety valve core, lower blocking 17, and reset spring of double valve are all arranged in a same center line respectively. Furthermore, monitor-control-drive circuit 9, parallel double valve monitor-control unit valve seat 10 or cross-flow double valve monitor-control unit valve seat 80, signal reset spring 22, signal piston 23, signal V-ring 24, signal back cover 25, and O-ring 26 form parallel or cross-flow safety control double valve monitor unit.

Besides, from DWGs of 3h, i, j, it is clear that double-cross-flow double valve includes 2-position Tee pilot solenoid, same as in parallel double valve, and mounted on pilot valve seat 112, too, quick exhaust blocking 34 is put into pilot valve seat 112, and the pilot valve seat 112 is mounted on double-cross-flow double valve body 113. While the main valve component is composed of 3 same sets of piston 11, V-coil 12, V-blocking 14, and 2 groups of same valve rod 13, double-cross-flow double valve spacer 102 lower blocking 101, lower valve core 114, reset spring 103, lower end cap 19, lower end hole cover baffle ring 21, a double-cross-flow double valve body 113, c safety valve reset spring 28 and safety valve rod 29. The valve core component is composed of master valve piston 11 inside double-cross-flow double valve body 113, V-ring 12—which is put on piston 11, and valve rod 13, which is pressed into the central hole of the piston. Put V-blocking 14 in the center of valve core component, and then put into double-cross-flow spacer 102, to form double-cross-flow double valve core component; at the same time, after piston 11 and V-ring 12 sleeve pressed together into safety valve rod 29 into the center hole of piston, and then put in the V-blocking 14, and then together with safety valve reset spring 28 to form safety valve core. Put the double-cross-flow double valve core component into relevant double-cross-flow double valve body 113 lower valve cavity respectively and 2 sets of lower blocking 101, lower valve core 114, reset spring 103, and then put in the baffle ring 21 clamped lower end cap 19 with end-cap O-ring 20; the feature in structure of double-cross-flow double valve is that the internal cavity of double-cross-flow double valve body 113, valve core of double-cross-flow double valve, safety valve core, lower blocking 101, lower valve core 114 and reset spring 103 are all central lined respectively in each valve cavity. Furthermore, monitor-control-drive circuit 9, double-cross-flow double valve monitor unit valve seat 80, signal reset spring 22, signal piston 23, signal V-ring 24, signal back cover 25, O-ring 26 double-cross-flow double valve monitor unit. The monitor circuit unit of double-cross-flow double valve collects all electric signals from aero-electric converter mounted in the way of flow passage from the lower valve opening 62 of double valve to, compressed air exit OUT, so as to perform monitoring to the trouble or dangerous trouble of the double-cross-flow double valve.

From DWGs 4a, 5a, it is clear that When 1DT and 2DT in Coil 1 power down simultaneously, after reset of the pilot solenoid, the quick exhaust blocking 34 inner pilot valve seat is free from control press, open quick exhaust blocking 64, then the compressed air inner double valve control cabin shall release from respective blocking 64 in relevant pilot valve seat 8, and 2 reset springs 18 of the double valve shall push respective blocking 17 moving upward and close up the lower valve opening 62, the up-moving lower blocking 17 shall push respective valve core moving upward to open corresponding upper valve opening 63, and let the compressed air inner said safety control double valve controlled clutch release from the circular flow passage at valve core and upper valve opening 63 of the double valve to exhaust vent EXT2 and escape to atmosphere.

From DWG 4a: When the double valve is of parallel double valve, and 1^{st} coil 1DT and 2^{nd} coil 2DT in the each Coil 1 of the pilot valves energized simultaneously, the compressed air shall enter respective control cabin 61 through respective pilot solenoid through pilot valve seat 8, the 2 two valve cores of parallel double valve 56 moving downward simultaneously to overcome the resistance of spring 18, and the parallel double valve spacer 15 and push respective lower blocking 17, open lower valve opening 62 of parallel double valve 56, and close-up upper valve opening 63 of parallel double valve 56 under the pushing from compressed air, which passes compressed air intake IN of parallel control double valve and from the circular flow passage at parallel double valve spacer 15 and lower valve opening 62 to the output vent 60 of parallel double valve 56, and shall be sent into the clutch controlled by the said safety control double valve through the compressed air output vent OUT of parallel safety control double valve.

From DWG 5a: When the double valve is cross-flow double valve 96, and 1^{st} coil 1DT and 2^{nd} coil 2DT in the each Coil 1 of the pilot valves energized simultaneously, the compressed air shall enter respective control cabin 61 through respective pilot solenoid through pilot valve seat 8, the 2 two valve cores of cross-flow double valve 96 moving downward simultaneously to overcome the resistance of spring 18, and the cross-flow double valve spacer 81 and push respective lower blocking 17, open lower valve opening 62 of cross-flow double valve 96, and close-up upper valve opening 63 of cross-flow double valve 96 under the pushing from compressed air, which passes compressed air intake IN of cross-flow control double valve and 2^{nd} throttle column 78, 79 and its corresponding throttle holes 87, 88 formed circular flow passage to 2^{nd} imaging terminals 86, 73, then, the compressed air flows along its corresponding cross-flow double valve compressed air output vent OUT through the other end connective 1^{st} imaging terminals 74, 32 which is connective to at parallel double valve spacer 15 and lower valve opening 62 to the output vent 60 of parallel double valve 56, and shall be sent into the clutch controlled by the said safety control double valve through the compressed air output vent 60 connected OUT of cross-flow safety control double valve.

From DWG 5f: When the double valve is of double-cross-flow double valve 100, and 1^{st} coil 1DT and 2^{nd} coil 2DT in the each Coil 1 of the pilot valves energized simultaneously, the compressed air shall enter respective control cabin 61 through respective pilot solenoid through pilot valve seat 8, the 2 two valve cores of double-cross-flow double valve 100 moving downward simultaneously to overcome the resistance of spring 103, and the double-cross-flow double valve spacer 102 and push respective lower blocking 101 and lower valve core 114, open lower valve opening 62 of double-cross-flow double valve 100, and close-up upper valve opening 63 of double-cross-flow double valve 100 under the pushing from compressed air, which passes compressed air intake IN of cross-flow control double valve and master circular flow passage 104,107 on the lower valve core 114, and flows into 2^{nd} imaging terminals 86, 73, the other end of 2^{nd} imaging terminals 86, 73 corresponding the connective 1^{st} terminals 74, 32, and then, flows into double valve compressed air output vent OUT through circular throttle flow passage 111, 110 of the double-cross-flow safety control double valve, and is then sent to the clutch the said safety control double valve controlled.

When the parallel double valve 56 in the parallel safety control double valve is under trouble conditions, as is shown in DWG 4c, there is only one of 1^{st} coil 1DT and 2^{nd} coil 2DT energized, and the other is not energized, the valve core corresponding to the energized coil shall move downward under the push of compressed air to overcome the resistance from spring 18, spacer 15 of the parallel double valve shall push lower blocking 17, and open lower valve opening 62, then the compressed air shall flow from compressed air intake IN of the parallel double valve and passes the main flow passage at parallel double valve spacer 15 and lower valve opening 62 into the output vent of parallel double valve 56; the valve core corresponding to the other un-energized coil shall close up the lower valve opening 62, and open upper valve opening 63, the effective cross-section from the intake of parallel double valve 56 to output vent 60 is just ¼ that of from the output vent 60 to double valve exhaust vent EXT2, therefore, most part of compressed air flowing into intake vent IN of parallel safety control double valve through the upper valve opening 63 opened by the valve core corresponding to the coil not energized and exhaust to atmosphere through double valve exhaust vent EXT2, the pressure at intake opening 59 of added safety valve 55 aside the compressed air output vent OUT of parallel double valve is only 5-10% (25˜50 KPa) that of intake vent compressed air pressure, aero-electric signal converter 57 sampled air pressure at sampling port 70 is only 25˜50 KPa, and at this moment, the low-pressure signal issued from aero-electric signal converter 57 is fed to the monitor-control-drive circuit 9 of the said parallel safety control double valve, for analysis and comparing, when trouble result at parallel double valve 56 is yielded, the trouble monitor output terminals 45, 46, 47 shall issue trouble signal instantly, and drive safety valve 55 to let power of and turn direction the 3^{rd} coil 3DT in the safety valve, open upper valve opening 58 of safety valve 55, to release the residue compressed air through EXIT1 again into the atmosphere, and thus the pressure at OUT of parallel safety control valve is further descended (10˜25 KPa), and self-locked to maintain such a state until reset because of the monitor power cut off.

When cross-flow double valve in cross-flow safety control double valve 96 is under trouble conditions, as is shown in DWG 5c, there is only one of 1^{st} coil 1DT and 2^{nd} coil 2DT energized, a valve core in corresponding to the energized coil moves downward under the compressed air press to overcome the resistance of spring 18, the cross-flow double valve spacer 81 pushes lower blocking 17 to open lower valve opening 62, and the compressed air flows from compressed air intake IN to the 2^{nd} imaging terminal, opens the 2^{nd} throttle column and through relevant throttle hole formed flow passage, the compressed air flown into the 2^{nd} imaging terminals flows along with corresponding connective flow passage into another lower valve opening not opened imaging terminals of the valve core, after passing the 1^{st} throttle column of said corresponding output vent 60 of cross-flow double valve 96, while under trouble conditions of a single valve, the effective cross-section of compressed air intake IN to output vent 60 is far more smaller than the effective cross section from output vent 60 to double valve exhaust vent EXT2, therefore, the compressed air flown into cross-flow safety control double valve intake IN is mostly released to the atmosphere through the way from upper valve opening of corresponding valve core opened upper valve vent 63 corresponding to the un-energized coil through exhaust vent EXT2 of the double valve, t, The pressure of compressed air at intake 59 of compressed air output vent OUT side-added safety valve 55 is just 5% (25 KPa) than that of the pressure at intake, and at this moment, low air pressure signal issued by aero-electric signal converter 57 is sent to monitor-control-drive circuit 9 of the said cross-flow safety control double valve for analysis and comparing, and when the result of state of the cross-flow double valve is under trouble yielded, it shall issue trouble signals through monitor output terminals 45, 46, 47 instantly and drive safety valve 55 to power down the 3^{rd} coil 3DT, and turn direction and open upper valve opening 58 of the safety valve 55, so as to let the residue of compressed air release again to the atmosphere through safety valve exhaust vent connective to clutch EXT1, the pressure at compressed air output vent OUT is further lowered (10 KPa), and maintain self-lock state, up to reset owing to monitor power supply cutting off.

When cross-flow double valve in double-cross-flow safety control double valve 100 is under trouble conditions, as is shown in DWG 5g, there is only one of 1^{st} coil 1DT and 2^{nd} coil 2DT energized, and another one is not energized, a valve core in corresponding to the energized coil moving downward under the compressed air press to tackle reset spring 103, the double-cross-flow double valve spacer 102 pushes lower blocking 101 and lower valve core 114 to open lower valve opening 62, the compressed air flow flows from compressed air intake IN of double-cross-flow double valve through the master circular flow passage 115 designed in lower valve core 114 to the 2^{nd} imaging terminal 73, and further flows along with the flow passage 33 into another un-opened 1^{st} imaging terminal 32 of lower valve opening, since lower blocking 101 blocked lower valve opening 62, this compressed air flow is unable flowing to the output vent 62 of double-cross-flow double valve through circular flow passage in the double-cross-flow double valve. While the other compressed air flow flows through a circular throttle flow passage 115 in another lower valve 114 and flowing the flow passage 72 to the circular flow passage 110 in connective double-cross-flow double valve, and then scattered to double-cross-flow safety control double valve output vent OUT and safety valve exhaust vent EXT1, the exhaust vent of double valve, because of the dual influence of circular throttle flow passage 110 in double-cross-flow double valve and circular throttle flow passage 105 in lower valve core 114, the flow rate of in-flow compressed air is far more less than the How rate through double-cross-flow safety control double valve output vent OUT and safety valve exhaust vent EXT1, and at this moment, the pressure at double-cross-flow safety control double valve output vent OUT is far more lower than the drive pressure for clutch being controlled; while double-cross-flow safety control double valve 100 under condition of a single valve failure, the action process and result are as the same with that of cross-flow double valve 96, let residue of compressed air at clutch connective double-cross-flow safety control double valve compressed air output vent OUT exhaust to atmosphere again through safety valve exhaust vent EXT1, the pressure at double-cross-flow safety control double valve compressed air output vent OUT is even lower (10 KPa), and maintain the state self-locked, till reset by monitor power supply cut-off.

When the parallel double valve 56 in the safety control double valve is under dangerous failure state, as is shown in DWG 4d, 1^{st} coil 1DT and 2^{nd} coil 2DT are all under power-down status, but both of the cores of 2 pilot valves or master valve are choked,at this, moment, high air pressure signal issued by aero-electric signal converter 57 is fed to said safety control double valve monitor-control-drive circuit 9 for analysis and comparing, and “when 1^{st} coil 1DTand 2^{nd} coil 2DT of parallel double valve 56 power down, but the output vent 60 still shows high pressure, that indicates safety control double valve has been under the state of dangerous failure” is reported, assign immediately signal to pressing machine through trouble monitor output terminals of 45, 46, 47 and drive safety valve 55, open exhaust vent 58 of safety valve. The effective cross section from parallel valve 56 intake to output vent 60 is only ¼ that of the cross section from safety valve exhaust vent EXT1, therefore, the compressed air flown into the intake IN of parallel safety control double valve is mostly exhausted to the atmosphere through safety valve exhaust vent EXT1; at the same time, the compressed air of parallel safety control double valve and clutch connective with compressed air output vent OUT is also escape to the atmosphere through safety valve exhaust vent, and let the pressure at compressed air output vent OUT be lower than 40 KPa, and maintains such a state by self-locking, till reset when monitor power supply is cut off The target of available for safety control under the conditions of 2 single valve formed parallel double valve are failed at the same time is achieved.

When cross-flow double valve 96 in safety control double valve is under dangerous failure conditions, as sown in DWG 5d, is coil 1DT and 2^{nd} coil 2DT are all under power-down status, but both of the cores of 2 pilot valves or master valve are choked, at this moment, high air pressure signal issued by aero-electric signal converter 57 is fed to said safety control double valve monitor-control-drive circuit 9 for analysis and comparing, and “when two coils 1 of cross-flow double valve 96 power down, but the output vent 60 still shows high pressure, that indicates cross-flow safety control double valve has been under the state of dangerous failure” is reported, assign immediately signal to pressing machine through trouble monitor output terminals of 45, 46, 47 and drive safety valve 55, open exhaust vent 58 of safety valve. The effective cross section from cross-flow double valve 96 intake to output vent 60 is only ¼ that of the cross section from safety valve exhaust vent EXT1, therefore, the compressed air flown into the intake IN of cross-flow safety control double valve is mostly exhausted to the atmosphere through safety valve exhaust vent EXT1; at the same time, the compressed air of cross-flow safety control double valve and clutch connective with compressed air output vent OUT is also escape to the atmosphere through safety valve exhaust vent, and let the pressure at compressed air output vent OUT be lower than 40 KPa, and maintains such a state by self-locking, till reset when monitor power supply is cut off. The target of available for safety control under the conditions of 2 single valve formed cross-flow double valve are failed at the same time is achieved.

When double-cross-flow double valve 100 in safety control double valve is under dangerous failure conditions, as sown in DWG 5h, 1^{st} coil IDT and 2^{nd} coil 2DT are all under power-down status, but both of the cores of 2 pilot valves or master valve are choked, at this moment, high air pressure signal issued by aero-electric signal converter 57 is fed to said safety control double valve monitor-control-drive circuit 9 for analysis and comparing, and “when two coils 1 of cross-flow double valve 100 power down, but the output vent 60 still shows high pressure, that indicates double-cross-flow safety control double valve has been under the state of dangerous failure” is reported, assign immediately signal to pressing machine through trouble monitor output terminals of 45, 46, 47 and drive safely valve 55, open exhaust vent 58 of safety valve. The effective cross section from double-cross-flow double valve 100 intake to output vent 60 is only ¼ that of the cross section from safety valve exhaust vent EXT1, therefore, the compressed air flown into the intake IN of cross-flow safety control double valve is mostly exhausted to the atmosphere through safety valve exhaust vent EXT1; at the same time, the compressed air of cross-flow safety control double valve and clutch connective with compressed air output vent OUT is also escape to the atmosphere through safety valve exhaust vent, and let the pressure at compressed air output vent OUT be lower than 40 KPa, and maintains such a state by self-locking, till reset when monitor power supply is cut off. The target of available for safety control under the conditions of 2 single valve formed cross-flow double valve are failed at the same time is achieved.

The composition of safety control double valve monitor-control-drive circuit 9 is shown in DWG 6. The sampling, analyzing, comparing controlling drive circuit 41 in monitor-control-drive circuit 9 may be composed of micro-relay, analog switch electronic circuit and single chip electronic circuit and etc programs.

In order to improve the safeness reliability of parallel or cross-flow type of safety control double valve in operation and actualize redundant control to the safety performance of double valve, the operation power supply of safety valve 55 and monitor-control-drive circuit 9 is additionally equipped, monitor power supply—in same pase ans with same voltage—for such kind of parallel or cross-flow safety control valves. Apart from control interface terminals of 42, 43, 44 for sampling-analyzing-comparing control drive circuit 41 for normal pressing machine control in the said safety control double valve, and trouble monitoring output terminals 45, 46, 47 for the issue of monitored failure signals when double valve encountering failure during operation, it is also needed to configure another monitor power supply terminals 48, 49 for monitor-control-drive circuit 9. In order to ensure the monitor power can supply monitor-control-drive circuit 9 correctly and reliably, the sampling-analyzing-comparing circuit 41 in safety control double valve monitor-control-drive circuit 9 actualizes the performance of power-off for the 3^{rd} coil of the safety valve 55 to open the upper valve opening 58 when the monitor power supply is abnormal for parallel or cross-flow type of double valve, and then the compressed air output vent OUT of parallel or cross-flow double valve is connective with safety valve exhaust vent EXT1, no mater whether energized or power-off of the 1^{st} coil and 2^{nd} coil in parallel or cross-flow double valve Coil 1, the pressure at compressed air output OUT of the said parallel or cross-flow double valve is always lower than 40 KPa.

The structure drawing is shown in DWGs 7a, b, c, the monitor unit of parallel safety control double valve contains 3 cable terminal connectors 35, monitor unit valve seat 10, metal flex pipe connector 36, lumbar ring 37, proximity-switch 38, shaped-ring 39, signal reset spring 22, signal piston 23, signal V-ring 24, signal back-cover 25, and O-ring 26. Mount the 3 cable terminals 35 on monitor unit valve seat 10, so as to fix and roll-tight the lead cable and input cable of the parallel double valve 56, the compressed air coming from compressed air intake IN is sent to valve body 16 through lumbar-ring, so as to control the pilot air supply, use lumbar-ring 37 as sealing washer between valve body 16 and monitor unit valve seat for pilot air supply, use shaped-ring as sealing washer 39 between master master intake air flow passage, output air-flow passage and other flow-passage of the valve-body and monitor valve seat 10. The sampling port 70 of aero-electric signal convert 57 is located at the down-stream of parallel double valve 56.

When the compressed air pushes moving upward the signal piston 23, to approach proximity switch 38 or micro-switch 71 in DWG 10, the proximity switch 38 or micro-switch in DWG 10 shall issue high-pressure air signal, and feed the high pressure air signal to monitor-control-drive circuit 9 for processing. When the pressure at sampling port 70 of compressed air faded away indicated by the signal from aero-electric signal converter, the signal piston 13 resets by the action of signal reset spring 22, and that lets proximity switch 38 or micro-switch 71 shown in DWG 10 issue electric signal of low air-pressure or 0 signal of air pressure, and it can be also fed to monitor-control-drive circuit 9 for processing.

The structure of cross-flow control double valve monitor unit is shown in DWGs 8a, b, c; the monitor unit of cross-flow monitor unit contains 3 cable terminal connectors 35, monitor unit valve seat 80, metal flex pipe connectors 36, proximity switch 38, shaped-ring 89, signal reset spring 22, signal piston 23, signal V-ring 24, signal back cover 25, and O-ring 26. Turn-fix the 3 cable terminal connectors 35 and metal flex pipe connectors on the monitor valve seat 10, so as to fix and roll-tight the lead cable and the inlet cable for safety valve 55 and cross-flow double valve 96, the compressed air from intake IN of compressed air is used to control pilot air supply through valve body 16, and shaped washers 89 are used between master intake flow-passage and output flow-passage of cross-flow double valve and between valve body 82 for other flow-passage and monitor unit valve seat 80. The air pressure sampling port 70 of aero-electric signal converter is located at the down stream of the output vent of cross-flow double valve 96. When the compressed air flow passed flow-passage 84 to air pressure sampling port 70, the compressed air pushes signal piston 23 moving upward, to approach proximity switch 38 or push micro-switch 53 in DWG 10, so as to issue signal of high air pressure, and feed the high air pressure signal to monitor-control-drive circuit 9 for processing. When the pressure at sampling port 70 of compressed air faded away indicated by the signal from aero-electric signal converter, the signal piston 13 resets by the action of signal reset spring 22, and that lets proximity switch 38 or micro-switch 71 shown in DWG 10 issue electric signal of low air-pressure or 0 signal, of air pressure, and it can, be also fed to monitor-control-drive circuit 9 for processing.

Besides, confer DWG 1d, the monitor unit of cross-flow safety control double valve can also configure one air pressure signal sampling port 70 of aero-electric signal converter 70 each at 1^{st} imaging port 32—2^{nd} imaging port 73—air flow passage 33 and 1^{st} imaging port 74—2^{nd} imaging port 86—air flow passage, which are cross-flow passages not connective from each other, and per DWG 11, configure aero-electric signal converters 57 for the two air-pressure sampling ports 70 respectively and accordingly, the electric signal yielded from the two aero-electric signal converters 70 is also fed to monitor-control-drive circuit 9 for processing, and control safety valve per the processed result.

When pressure transducer 53 in DWG 9 is used to replace proximity-switch 38, signal piston 23, signal reset spring 22 and etc parts in the monitor unit shall be canceled, and make changes per DWG 9; the 1^{st} electric signal converted from pressure transducer and the 2^{nd} and 3^{rd} signals output from 2 Coil 1 of double valve are fed to sampling-analyzing-driving circuit 41 of monitor-control-drive circuit 9 for XOR logic text, analysis and control. The feature of that is relatively simple and reliable, only but of high cost.

The monitor-control-drive circuit 9 of such kind of safety control double valve collects signals from signals for 1^{st} coil 1DT and 2^{nd} coil 2DT of Coil 1 in double valve of the said safety control double valve, signal, from aero-electric converter 57 is also collected, and these three signals are fed to sampling—analyzing—comparing—control drive circuit 41 of monitor—control—drive circuit 9 for test, analysis and control, so as to actualize and accomplish XOR logic safety control per air pressure signals issued by 2 controlled electric signals from cross-flow double valve in double valve 56 of such kind of safety control double valve and air pressure signal from aero-electric signal converter 57 mounted at the safety control double valve exhaust vent.

Besides, the monitor-control-drive circuit 9 of such a kind of safety control double valve can also be configured in the internal circuit of correspondingly controlled pressing machine, it can also actualize and accomplish collecting signals from 1^{st} coil 1DT and 2^{nd} coil 2DT of 2 Coil 1 in double valve of the said safety control double valve, it also collects signal issued by aero-electric signal converter 57, and feed these 2 group 3 sigials to monitor-control-drive circuit 9 for test, analysis and control, so as to actualize and accomplish XOR logic safety control per air pressure signals issued by 2 controlled electric signals from cross-flow double valve 96 or double valve 56 and air pressure signal from aero-electric signal converter 57 mounted at the safety control double valve exhaust vent.

1. Power-Off-Protection Type of Safety Control Double Valve Applied to Pressing Machines, including parallel double valve (56) composed of intake, vent and exhaust vent directly paralleled by 2-single solenoids or cross-flow double valve (96) formed by cross imaging parallel; add safety valve (55) to output vent (60) of parallel double valve (56) or cross-flow double valve (96); configure at least one aero-electric signal converter (57) at flow passage from lower valve opening (62) of parallel double valve (56) or cross-flow double valve (96) to compressed air output vent (OUT)), configured monitor-control-drive circuit (9) to the said safety control double valve or in control circuit relative to controlled pressing machine corresponding to safety control double valve; the feature covers: out vent (60) of parallel double valve (56) or cross-flow double valve (96) is connective with intake (59) located at one end of safety valve (55); the other end of safety valve (55) is connective with exhaust valve vent (58), exhaust valve vent (58) is connective with safety valve vent (EXT1); the said safety valve (55) is a 2-position 2-way normal open solenoid valve;
configure at least one aero-electric signal converter (57) at the flow passage from lower valve opening (62) of said parallel double valve (56) or cross-flow double valve (96) to compressed an exit (OUT), of the said aero-electric signal converter (57) is connected to monitor-control-drive circuit (9) electrically; the said single type of solenoid valve and safety valve (55) include pilot valve (65), which is mounted on the pilot valve seat (8), and the master valve mounted beneath the pilot valve seat: the said compressed air output vent (OUT) of safety control double valve locates at one side of safety valve (55), the compressed air intake (IN) of safety control valve locates at the other side relative to the other side of compressed air output vent (OUT).

2. The said claim 1 power-off-protection type of safety control double valve applied for pressing machine is characterized in that the signal input terminals of the said monitor-control-drive circuit (9) are electrically connective respectively to signal output terminals of aero-electric signal converter (57) and the 2 Coils (1) of parallel double valve (56) or cross-flow double valve (96); the electric signals output from the 2 coils (1) of parallel double valve (56) or cross-flow double valve (96) are the 1^{st} and 2^{nd} electric signals, and the electric, signals output from the aero-electric signal converter are the 3^{rd} and 4^{th} signals; the said 1^{st}, 2^{nd}, and 3^{rd} or 4^{th} electric signals are fed to sampling analysis comparing control circuit of the monitor-control-drive circuit (9) for analysis and comparing, it indicates that the safety control double valve is in normal operation if the 1^{st}, 2^{nd}, and 3^{rd} or 4^{th} electric signals are all of high level or low level, and it indicates that there is trouble in operation of the safety control double valve if the 1^{st}, 2^{nd}, and 3^{rd} or 4^{th} electric signals are not of the same level, then, the sampling, analysis, comparing control drive circuit (41) shall drive instantly the safety valve (55) to actuate the response of power-off., release the compressed air vent (OUT) pressure of the safety control double valve, and lock the said release state, issue signal of failure.

3. The said claim 1 power-off-protection type of safety control double valve applied for pressing machine is characterized in that the external monitor power supply interface configured in the said monitor-control-drive circuit (9): only when the said monitor-control-drive circuit (9) is proficient to judge external power and supplied to energize the 3^{rd} coil (3DT) of the safety valve (55), close the safety valve exhaust vent of safety valve (55), can then the safety control double valve operates normally and actualize the effective monitoring for the external power supply for the safety control double valve, and at the same time, accomplish the performance self-test of the safety control double valve before operation.

4. The said claim 1 power-off-protection type of safety control double valve applied for pressing machine is characterized in that: the upper valve opening (63) of parallel double valve or cross-flow double valve (96) to double valve exhaust vent (EXT2) forms an exhaust cavity (31) which is independent each other to the exhaust cavity (30) formed from exhaust valve vent (58) of safety valve (55) to safety valve exhaust vent (EXT1); when, safety valve (55) power-off, the safety exhaust vent (58) is opened after the pressing machine sudden power down, parallel double valve (56) or cross-flow double valve (96) in the safety control double valve, which controls clutch therein, and the safety valve are all in safe state, i.e., the compressed air exhaust vent (OUT) is connective simultaneously to the exhaust vent (EXT2) of parallel double valve (56) or cross-flow double valve (96) and the safety valve exhaust vent (EXT1), so as to actualize the redundant control to the safety control features of safety control double valve.

5. The said claim 1 of safety control double valve is characterized in that: the said aero-electric signal converter is a signal converter containing micro-switch; in the said micro-switch contained aero-electric signal converter, the signal piston (23) is of slip-connection type, the piston rod of the signal piston (23) extrudes one end of the said cylinder, the extruding end of piston rod can, touch with micro-switch mounted on monitor unit valve seat (10), the other end of the cylinder body is equipped with signal back cover (25), there is a signal reset spring (22) outside the piston rod; the said monitor unit valve seat (10) is located at the side of valve body (16), and the said cylinder body is located on the said monitor valve seat (10); the said micro-switch is connective to monitor-control-drive circuit (9) electrically.

6. The said claim 1 of safety control double valve applied for pressing machine is characterized in that: the said aero-electric signal converter is a signal converter containing proximity-switch; in the said micro-switch contained aero-electric signal converter, the signal piston (23) is of slip-connection type, the piston rod of the signal piston (23) extrudes one end of the said cylinder, the extruding end of piston rod can proximity the induction surface of proximity-switch mounted monitor unit valve seat (10), the other end of the cylinder body is equipped with signal back cover (25), there is a signal reset spring (22) outside the piston rod; the said monitor unit valve seat (10) is located at the side of valve body (16), and the said cylinder body is located on the said monitor valve seat (10); the said proximity-switch is connective to monitor-control-drive circuit (9) electrically.

7. The said claim 1 of safety control double valve is characterized in that: the said aero-electric signal converter is an aero-electric signal converter containing transducer; in the said aero-electric signal converter containing transducer, the monitor unit valve seat (10) is located at the side of valve body (16), a cavity is configured in the monitor unit valve seat (10), there is pressure transducer (53) in the said cavity, there is a signal back cover (25) used for arrange pressure transducer (53) for positioning and sealing at the cavity opening end; the said pressure transducer is connective with monitor-control-drive circuit (9) electrically.

8. The said claim 1 of safety control double valve is characterized in that: when monitor-control-drive circuit (9) configured in the corresponding control circuit of pressing machine to be controlled, monitor-control-drive circuit (9) is electrically connected to aero-electric signal converter (57), which is in the safety control double valve to be controlled, output terminals and coils of 1^{st} (1DT) and 2^{nd} (2DT) of the two coils of parallel double valve (56), and the 3^{rd} coil (3DT) of safety valve; besides of actualizing collect signals from 1^{st} (1DT) and 2^{nd} (2DT) of the said double valve in safety control double valve for pressing machine, it also collects electric signal issued from aero-electric converter (57), and feed these three signals to monitor-control-drive circuit (9) for measuring, analyzing and controlling; actualizing the logic safety control according to the air pressure signals of 2 electrically controlled signals from parallel double valve (56) or cross-flow double valve (96) in safety control double valve and the signal issued by the aero-electric converter (57) mounted at the output vent of safety control double valve.
